(19) United States
(12) Patent Application Publication
(10) Pub. No.: US 2010/0029198 A1
(43) Pub. Date: Feb. 4, 2010

(54) System and method for transmitting and receiving image data

(76) Inventors: Frank J. Hules, Calabasas, CA (US); Michael H. Laur, Mission Viejo, CA (US); Ed T. Dilley, Malibu, CA (US); Paul J. Ainslie, Indianapolis, IN (US); Steven P. Corda, Belle Mead, NJ (US); Robert K. Lukach, Hillsborough, NJ (US)

Correspondence Address: Delphi Technologies, Inc., M/C 480-410-202, PO BOX 5052, Troy, MI, 48007, US

(21) Appl. No.: 12/082,641

(22) Filed: Apr. 11, 2008

Related U.S. Application Data
(60) Provisional application No. 60/911,646, filed on Apr. 13, 2007.

(51) Int. Cl. H04B 7/185

(52) U.S. Cl. 455/13.1; 455/12.1

(57) ABSTRACT

A communication system and method for transmitting and receiving signals is provided. The system and method include a source provider that provides image data, at least one transmitter, at least one satellite, and at least one receiver. The at least one transmitter transmits the image data obtained from the source provider. The at least one satellite is in communication with the at least one transmitter and receives and retransmits the image data. The at least one receiver is in communication with the at least one satellite, wherein the at least one receiver is adapted to receive the retransmitted image data, is mobile, and includes at least one antenna. The at least one antenna includes at least a first antenna that has a horizontal length of less than approximately twelve inches (12 in.).

### CROSS-REFERENCE TO RELATED APPLICATION

This application claims the benefit under 35 U.S.C. §119(e) of U.S. Provisional Patent Application No. 60/911,646, filed on Apr. 13, 2007, the entire disclosure of which is hereby incorporated herein by reference.

### TECHNICAL FIELD

The present invention generally relates to a system and method for satellite communication, and more particularly, to a system and method for transmitting and receiving image data.

### BACKGROUND OF THE INVENTION

Current satellite television systems are generally designed for stationary receivers, such as a receiver used in a person's home, where the antenna is mounted to a stationary object. Thus, the systems are typically not designed for the receiver and/or antenna to be mobile while continuing to receive the satellite signals. The antennas are usually mounted on the exterior of the house and directed in the desired direction of the satellite, such that the direction the antenna is pointing is rarely altered and obstructions between the satellite and antenna are minimal.

However, when the receiver, including the antenna, are mobile, the pointing direction of the antenna with respect to the satellite or the direction of the antenna beam is constantly changing. When the antenna is not pointed in the correct direction with respect to the satellite, the antenna does not receive the satellite signal. Further, line of sight blockages between the antenna and the satellite can cause immediate loss of the reception of the signal, since the mobile receiver and antenna can pass by an object that prevents the antenna from receiving the satellite signal.

Additionally, current mobile satellite television systems generally require large dish shaped or circular horizontally flat antennas, typically greater than twenty-six inches (26 in.) in diameter, in order to receive the satellite television signals. Such large antennas are required because of the high data rates of satellite television signals, the loss of signal strength due to mounting and pointing constraints, and are generally complex and expensive to manufacture. Additionally, the larger antennas generally are not aesthetically pleasing, such that a manufacturer or owner of a vehicle would not desire the large antenna to be mounted to the vehicle. Also, the large antennas are generally not desired for integrating into vehicles due to the cost of integration. One such system proposed for use in a vehicle is described in U.S. Patent Application Publication No. 2006/0273967, entitled “SYSTEM AND METHOD FOR LOW COST MOBILE TV,” which teaches an antenna having a length between twelve inches (12 in.) and twenty-eight inches (28 in.).

### SUMMARY OF THE INVENTION

According to one aspect of the present invention, a communication system includes a source provider that provides image data, at least one transmitter, at least one satellite, and at least one receiver. The at least one transmitter transmits the image data obtained from the source provider. The at least one satellite is in communication with the at least one transmitter, and receives and retransmits the image data. The at least one receiver is in communication with the at least one satellite, is adapted to receive the retransmitted image data, is mobile, and includes at least one antenna. The at least one antenna includes at least a first antenna that has a horizontal length of less than approximately twelve inches (12 in.) (30.48 cm).

According to another aspect of the present invention, a method of satellite communication includes the steps of interleaving image data, transmitting interleaved image data to at least one satellite, and receiving and retransmitting the image data by the at least one satellite. The method further includes the steps of receiving the retransmitted image data by at least one receiver from the at least one satellite, wherein the at least one receiver is mobile, and de-interleaving the image data, such that the receiver employs an error correction technique to emit a substantially error free output when the receiver's visibility to the satellite is blocked for a period of time up to approximately twenty-five seconds (25 s).

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is an environmental view of a communication system in accordance with one embodiment of the present invention;

FIG. 2 is a block diagram of a communication system in accordance with an embodiment of the present invention;

FIG. 3A is a top perspective view of an antenna in accordance with one embodiment of the present invention;

FIG. 3B is a side perspective view of an antenna in accordance with one embodiment of the present invention;

FIG. 4 is a cross-sectional plan view of an antenna of a communication system across the line IV-IV of FIG. 3B in accordance with one embodiment of the present invention;

FIG. 5A is a perspective view of an antenna mounted to a vehicle in accordance with an embodiment of the present invention;

FIG. 5B is a top perspective illustration of the antenna mounted to the vehicle of FIG. 5A;

FIG. 6A is a perspective view of an antenna mounted to a vehicle in accordance with another embodiment of the present invention;

FIG. 6B is a perspective view of the antenna of FIG. 6A;

FIG. 7 is a schematic diagram illustrating the locational relationship between a vehicle and a satellite in accordance with one embodiment of the present invention;

FIG. 8 is a flow diagram illustrating a method of communicating a signal in accordance with one embodiment of the present invention;

FIG. 9 is a general illustration of an exemplary signal that is transmitted and received in a communication system;

FIG. 10 is a perspective cross-sectional view of the antenna of FIG. 4, in accordance with one embodiment of the present invention; and

FIG. 11 is a block diagram illustrating accelerometers and gyros for determining the attitude of a vehicle (e.g., roll, pitch, and yaw angles) to compute the angle between a vehicle and a satellite, in accordance with one embodiment of the present invention.

### DESCRIPTION OF PREFERRED EMBODIMENTS

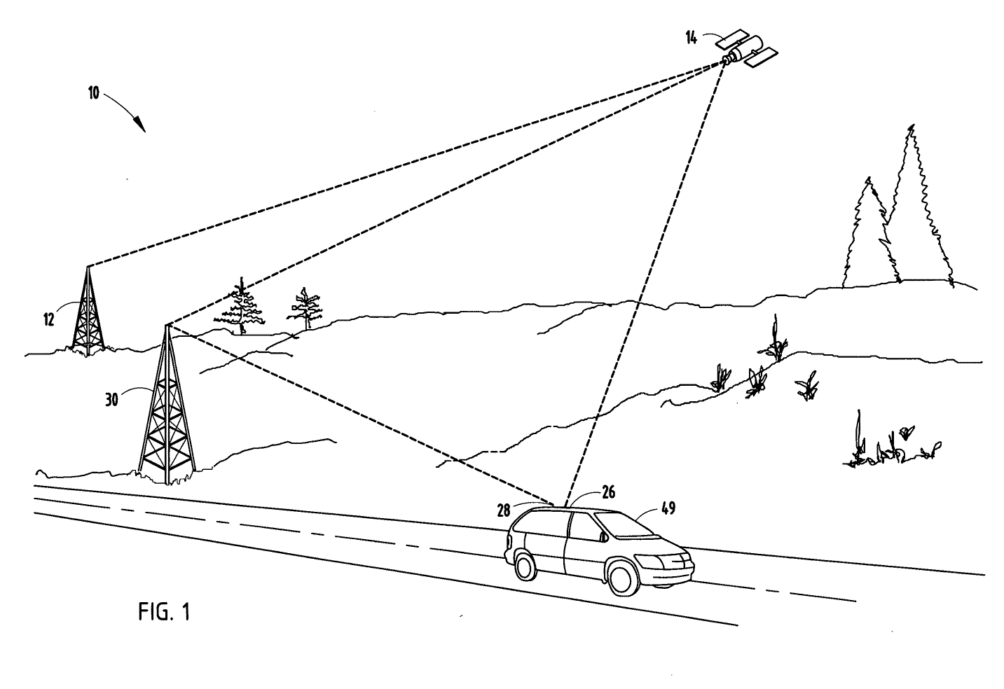

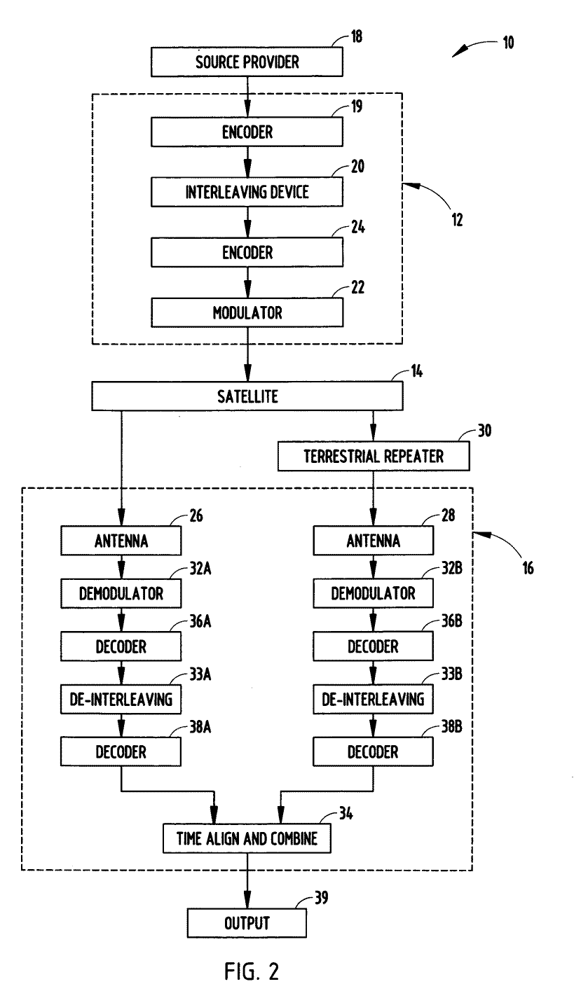

In reference to both FIGS. 1 and 2, a communication system is generally shown at reference indicator 10. The communication system includes at least one transmitter generally indicated at reference indicator 12, at least one satellite 14, and at least one receiver generally indicated at reference indicator 16. The transmitter 12 obtains data, including source data, from a source provider 18. According to one embodiment, the data that is transmitted and received in the communication system 10 is image data, such as, but not limited to, television broadcast data, Internet data, the like, or a combination thereof. Additionally, the transmitted image data can further include audio data, proprietary data for updating components of a vehicle 49, navigational system data, the like, or a combination thereof. The transmitter 12 transmits or uplinks the data to the satellite 14, and the satellite 14 receives and retransmits or downlinks the data to the receiver 16. Typically, the receiver 16 is mobile, such that the receiver 16 may be integrated, connected to, or located in the vehicle 49, airplane, train, boat or other watercraft, or other types of mobile devices or apparatuses.

The transmitter 12 contains devices for processing the data received from the source provider 18. The transmitter 12 can include an encoder 19 that encodes the data, and an interleaving device 20 for interleaving the data. Generally, interleaving is where data is re-ordered or shuffled and then transmitted in order to enable the receiver 16 to mitigate errors in the transmitted data resulting from line-of-sight blockages or other causes of rapid signal loss. Thus, when the transmitted data is received and de-interleaved, blocks of errors are broken up and spread out such that the probability of contiguous errors longer than a couple of bits is minimized, which can result in the errors being corrected by one or more forward error correction (FEC) techniques. According to one embodiment, the interleaving device 20 interleaves the data, such that the data can be corrected during long periods of signal blockages, as described in greater detail herein.

According to one embodiment, the transmitter 12 can also include an encoder 24 for encoding the data. One exemplary embodiment of the encoders 19,24 is a code division multiple access (CDMA) encoder or another encoder that encodes the data in another suitable spread spectrum format, or the like. Additionally, the transmitter 12 can include a modulator 22 for modulating the data. According to an exemplary embodiment, the modulator 22 can modulate the data using a modulation format, such as a binary phase-shift keying (BPSK) format or a quadrature phase-shift keying (QPSK) format. It should be appreciated by those skilled in the art that the data can be modulated using other suitable modulation formats. It should further be appreciated by those skilled in the art that the data can also be compressed, such as, but not limited to, a Moving Pictures Experts Group-4 (MPEG-4) format, to reduce the amount of bits or the size of the data that is being transmitted.

The satellite 14 receives the data from the transmitter 12 and retransmits the data to the receiver 16. According to one embodiment, the satellite 14 retransmits the data with a fixed output power and carrier frequencies. Typically, the encoding and modulation of the data by the transmitter 12 (e.g., encoders 19,24 and modulator 22) allows for multiple signals to occupy the same frequency space. Additionally, the satellite 14 can retransmit the data with a predetermined polarization, which can minimize interference from transmitted signals by other satellites. According to one embodiment, the polarizations of the data retransmission can be linear or circular, and the receiver 16 can be configured to receive one or both types of polarizations.

According to one embodiment, the at least one satellite 14 is a communications satellite, such as, but not limited to, a geostationary orbit (GEO) satellite, a low Earth orbit (LEO) satellite, a medium Earth orbit (MEO) satellite, a highly elliptical orbit (HEO) satellite, the like, or a combination thereof. Additionally, more than one satellite can be used to transmit the data at a single frequency or at different frequencies, such that the receiver 16 can receive the data from both satellites when receiving signals with more than one antenna, and the receiver 16 can combine the data.

The receiver 16 includes at least one antenna, such that a first antenna generally indicated at reference indicator 26 is in communication with the satellite 14. Additionally, the at least one antenna can further include a second antenna 28 that is in communication with the satellite 14 through a terrestrial repeater 30, as described in greater detail below. For purposes of explanation and not limitation, the description herein as to the first and second antennas 26,28 is not limiting the at least one antenna to such an embodiment, but is to illustrate an embodiment with two different antennas. It should be appreciated by those skilled in the art that the second antenna 28 can be configured to receive a signal from one or more satellites, the terrestrial repeater 30, the like, or a combination thereof.

According to one embodiment, the first antenna 26 can be configured to receive signals that are linearly polarized, circularly polarized, or both types of polarized signals. The receiver 16 can also include a demodulator 32A and a demodulator 32B to demodulate the data received from the first and second antennas 26,28, respectively. Also, the receiver 16 can include decoders 36A,36B that are associated with the encoder 24, wherein the decoder 36A is in communication with the demodulator 32A, and the second decoder 36B is in communication with the demodulator 32B. De-interleaving devices 33A,33B can also be included in the receiver 16 for de-interleaving the received data, wherein the de-interleaving device 33A is in communication with the decoder 36A and the de-interleaving device 33B is in communication with the decoder 36B.

Additionally, the receiver 16 can include decoders 38A,38B that are associated with the encoder 19, wherein the decoder 38A is in communication with the interleaving device 33A and the decoder 38B is in communication with the interleaving device 33B. According to one embodiment, the encoder 19 and decoders 38A,38B are Reed-Solomon encoders and decoders, and the encoder 24 and decoders 36A,36B are convolutional encoders and decoders. A time align and combine device 34 can also be included in the receiver 16 for time aligning and combining the transmitted data. The receiver 16 then emits an output 39 that can be, but is not limited to, a video output, an audio output, an image output, the like, or a combination thereof.

According to one embodiment, the data is temporally interleaved by the interleaving device 20 so that the receiver 16 continues to emit a desirable output 39 unless the line-of-sight between both the first and second antennas 26,28 and the satellite 14 and the terrestrial repeater 30, respectively, are blocked for a period of time that is greater than approximately twenty-five (25) seconds. Thus, the interleaving device 20 interleaves the data so that the receiver 16 can continue to output a desirable output 39 for such a period of time, as compared to devices that provide interleaving only for the mitigation of burst errors.

Typically, the data can be transmitted by the transmitter 12 using encoding that supports the use of one or more error correction techniques, such as, but not limited to, correcting errors using one or more FEC techniques upon receiving the transmitted signal. Additionally, when the blocks of errors are sufficiently large where FEC techniques are not completely effective, an interpolation technique may be employed to estimate data bit states from adjacent states to further enhance the quality of the output 39. Thus, the receiver 16 can use interpolation techniques alone or in combination with one or more FEC techniques to correct errors in the received data. Therefore, the receiver 16 can receive the signal with both the first and second antennas 26,28, de-interleave the received signals from both the first and second antennas 26,28, combine the de-interleaved signals, and then correct the combined signals for errors (e.g., one or more FEC techniques, interpolation, or a combination thereof).

According to one embodiment, the transmitted data is temporally interleaved over a time period greater than approximately fifteen seconds (15 s). In such an embodiment, the image data can be interleaved so that the receiver 16 can emit the output 39 based upon the received data when the receiver 16 is positioned as to not receive the interleaved data for a time period up to approximately twenty-five seconds (25 s). Thus, by interleaving the data, the receiver 16 can de-interleave the received data and employ one or more error correction techniques to emit a substantially error free output when the receiver's 16 visibility to the satellite 14 is blocked for a period of time up to approximately twenty-five seconds (25 s). However, according to an exemplary embodiment, wherein the transmitted data is being retransmitted by two sources (e.g., multiple satellites 14, a single satellite 14 and a terrestrial repeater 30, or a combination thereof), when the line-of-sight between the first antenna 26 and the satellite 14 is blocked, the signal may be received by the second antenna 28 based upon the retransmitted data from the terrestrial repeater 30, and thus, the one or more error correction techniques may not be needed in order for receiver 16 to emit an adequate output 39.

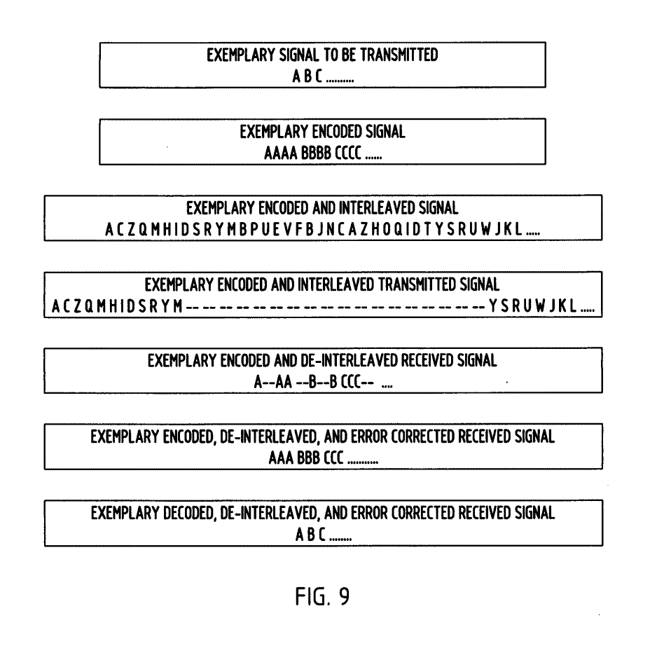

With respect to both FIGS. 2 and 9, a general illustration of an exemplary transmitted and received signal is shown in FIG. 9 to illustrate a basic concept of an interleaving process and effects thereof. The exemplary signal to be transmitted is represented by the alphabet characters “A B C . . . .” The exemplary encoded signal is represented by the alphabet characters “AAAA BBBB CCCC . . . .” The exemplary signal to be transmitted can be encoded by the encoder 19, according to one embodiment. The exemplary encoded signal can then be interleaved, such that the alphabet characters that represent the encoded signal are re-ordered (e.g., “A C Z Q . . . ”).

The exemplary encoded and interleaved transmitted signal can then be received by the receiver 16, wherein a portion of the signal represented by “--” represents a portion of the signal that is not received by the receiver 16. For purposes of explanation and not limitation, a portion of the transmitted signal may not be received by the receiver 16 due to a line-of-sight blockage between the satellite 14 and the receiver 16. The exemplary encoded and interleaved received signal can then be de-interleaved, so that the alphabet characters are rearranged to the original position, wherein the portion of the signal that is not received can be represented by “--”. The exemplary received signal can then be error corrected, such as applying one or more FEC techniques, as illustrated by the alphabet characters replacing “--”. The exemplary received signal can then be decoded, as illustrated by the alphabet characters “A B C,” such that the received signal corresponds to the exemplary signal to be transmitted. Thus, the receiver 16 can emit the output 39 based upon the received signal.

With respect to both FIGS. 1 and 2, according to one embodiment, the first antenna 26 is a low profile planar array printed patch antenna. In this embodiment, the first antenna 26 is substantially flat and has a horizontal length or horizontal measurement of less than approximately twelve inches (12 in.) (30.48 cm) and a vertical height of less than approximately two inches (2 in.) (5.08 cm), which can be inclusive of a pointing device and fixed base plate of the antenna 26. Typically, the first antenna 26 is configured to receive image data from the satellite 14 in either the fixed satellite service (FSS) band of approximately 11.7 gigahertz (GHz) to 12.2 GHz, or the broadcasting satellite service (BSS) band of approximately 12.2 GHz to 12.7 GHz. According to an alternate embodiment, the first antenna 26 is configured to receive data at the Reverse Ku frequency band of approximately 17.3 GHz to 17.8 GHz. One exemplary embodiment is where the data is retransmitted by satellite 14 at approximately 17.8 GHz. However, it should be appreciated that the first antenna 26 can be configured to have a modular interchangeable phased array to receive the data in other frequency bands, which may be implemented by the communication system 10.

According to one embodiment, the data is transmitted and received by the receiver 16 with a bit rate of approximately five hundred kilobytes per second (500 Kb/s) or greater. Typically, the data is received by the receiver 16 with a bit rate of approximately eight hundred kilobytes per second (800 Kb/s). The bit rate of the received data can be dependent upon the type of images being transmitted by the signal. By way of explanation and not limitation, a signal including data for cartoon images can be transmitted with a lower bit rate than images being transmitted for a sporting event, wherein the receiver 16 can emit an adequate output 39. Thus, by reducing the bit rate of the transmitted signal, the bandwidth of the transmitted signal is reduced when compared to a transmitted signal transmitting data at a higher bit rate. According to one embodiment, by reducing the bit rate of the transmitted signal, the bandwidth that is not otherwise being used can be used to implement higher performance signal encryption and decoding techniques.

According to one embodiment, the hardware, one or more executable software routines, or a combination thereof of the communication system 10 transmits the signal at a predetermined bit rate (e.g., determined at the time the communications system 10 is designed). The bit rate can be determined based upon the anticipated data to be transmitted in the communication system 10, the desired output 39, the like, or a combination thereof. According to an alternate embodiment, the hardware, one or more executable software routines, or a combination thereof of the communication system 10 transmits the signal at a bit rate, which is determined based upon the data that is being transmitted, such that the bit rate varies during operation of the communication system 10. In such an embodiment, the bit rate of the transmitted signal can be higher if the data of the transmitted signal relates to satellite television broadcast of a sporting event, when compared to the bit rate of the transmitted signal if the data of the transmitted signal relates to an audio broadcast. In such an embodiment, the transmitter 12 is configured to alter the bit rate of the transmitted signal, and the receiver 16 is adapted to determine if the bit rate of the transmitted signal has changed and configure accordingly. Alternatively, in such an embodiment, the transmitter 12 is configured to transmit another signal that is received by the receiver 16 when the transmitter 12 is altering the bit rate of the transmitted signal, and the receiver 16 configures accordingly to receive the transmitted signal at the altered bit rate.

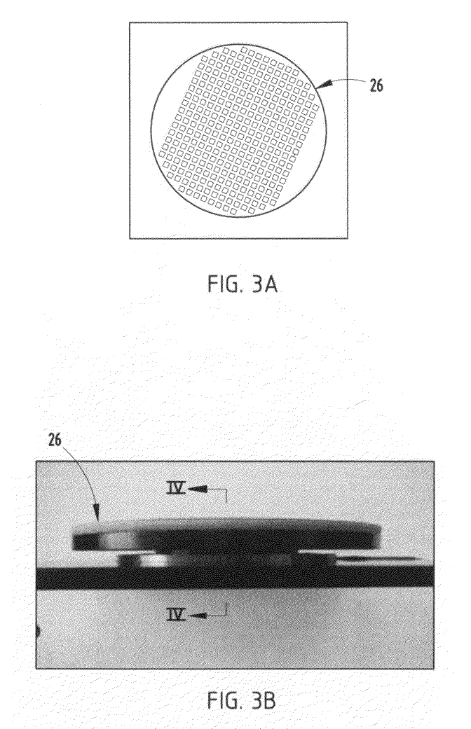

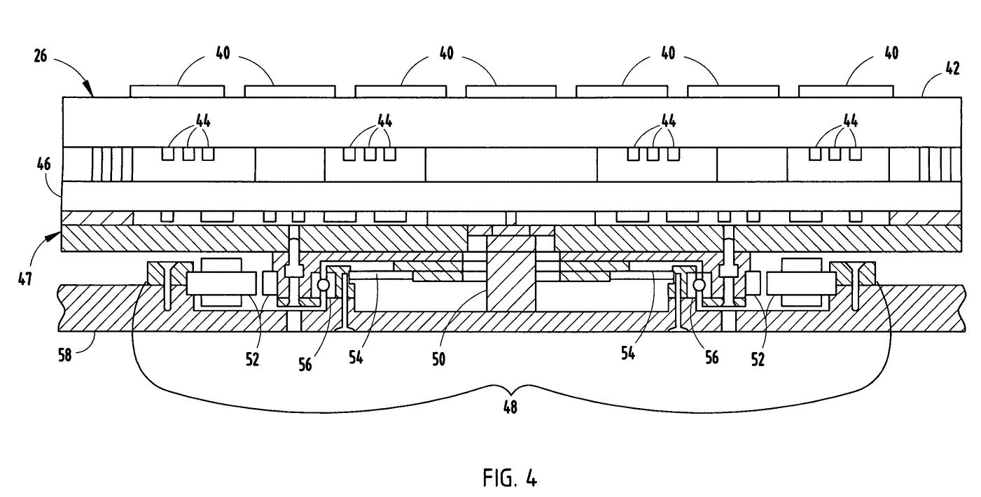

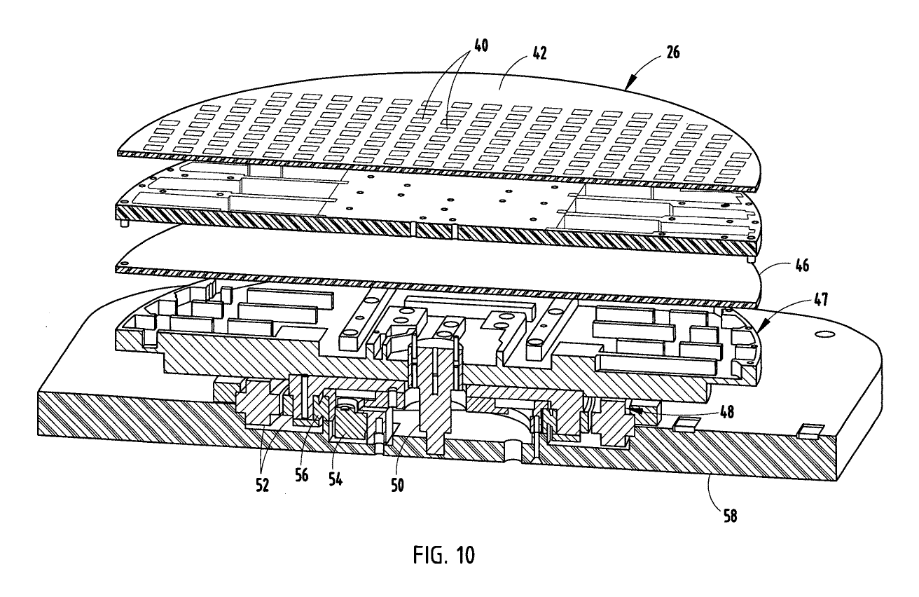

As shown in FIGS. 3-6 and 10, the first antenna 26 can include patch antenna elements 40 and an antenna layer 42. The first antenna 26 can also include amplifiers 44, which are typically low noise amplifiers, for amplifying the signal received from the satellite 14. Additionally, the first antenna 26 can include a down-converter layer 46 that down-converts the received frequency to a lower frequency, such that the data transmitted in a lower frequency can be processed by the other components of the receiver 16.

Typically, the down-converter layer 46 down-converts the frequency to a range of approximately 950 megahertz (MHz) to 2150 MHz.

Further, a positioning device generally indicated at reference indicator 48 is operably connected to the first antenna 26. According to one embodiment, the positioning device 48 is between an interposer 47 and a mounting plate 58. The positioning device 48 includes a rotary joint 50 and motor 52 for rotating the first antenna 26. An encoder 54 is used to determine the rotational location of the first antenna 26. The positioning device 48 can also include bearings 56 for rotating the first antenna 26 and the mounting plate 58 for connecting the first antenna 26 and positioning device 48 to the vehicle 49.

The first antenna 26 has a beamwidth so that the first antenna 26 receives signals from the satellite 14 within the beamwidth. When the first antenna 26 has a horizontal length of less than approximately twelve inches (12 in.) (30.48 cm), the three decibel (3 dB) beamwidth is approximately six degrees (6°) or greater. According to one embodiment, the first antenna 26 has a horizontal length of approximately ten inches (10 in.) (25.4 cm), and has a three decibel (3 dB) beamwidth of approximately 7.5°. Having a wide beamwidth greater than seven degrees (7°), allows the first antenna 26 to receive data from the satellite 14, even when the beam positioning of the first antenna 26 is not directly towards the satellite 14. By utilizing the first antenna 26 having a reduced size, the beamwidth of the first antenna 26 increases, such that the first antenna 26 can maintain communication with and sustain satellite 14 signal visibility without implementing a precise satellite 14 tracking system or method when compared to a larger antenna having a smaller beamwidth.

The beam positioning of the first antenna 26 is typically accomplished electronically for elevation and mechanically for azimuth. However, it should be appreciated by those skilled in the art that the beam positioning can be accomplished electronically, mechanically, or a combination thereof. When the data being received by the first antenna 26 is linearly polarized, the first antenna 26 can further include a mechanically positionable polarization steering lens to compensate for polarization misalignments. When the data being received by the first antenna 26 is circularly polarized, the first antenna can further include a patch design that allows for the reception of either left and/or right senses of polarization through switching, phase-shifting, and mechanical azimuth repositioning of the array. Thus, the first antenna 26 can include a microprocessor or other processing circuitry that is interfaced with components of the receiver 16 and other location devices to optimize antenna configuration and to determine the optimal beam positioning, as described in greater detail below.

According to one embodiment shown in both FIGS. 5A and 5B, the first antenna 26 can be embedded in a roof 60 of the vehicle 49. Thus, the receiver 16 is mobile by being integrated on a movable device or apparatus, such as the vehicle 49. By having the first antenna 26 with a horizontal length of less than approximately twelve inches (12 in.) (30.48 cm) and a vertical height of less than approximately two inches (2 in.) (5.08 cm) the first antenna 26 can be embedded in the roof 60 at the time of manufacturing the vehicle 49 with a reduced possibility of interfering with the structural components of the vehicle 49. Further, the antenna 26 can be embedded such that it is substantially flush with the exterior top-side of the roof 60 as well as the interior side of the roof 60, while still being able to be fully positionable to receive the signals from the satellite 14.

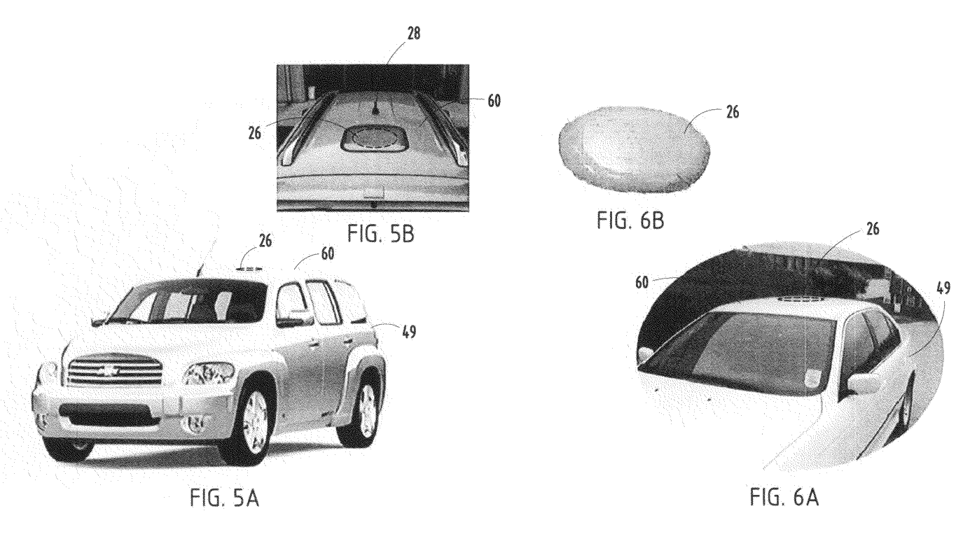

In an alternate embodiment shown in both FIGS. 6A and 6B, the first antenna 26 can be mounted or connected to the roof 60. The first antenna 26 could be attached using any suitable form of attachment. For purposes of explanation and not limitation, the first antenna 26 could employ a magnet to hold the antenna 26 in place on a metal roof. Thus, the first antenna 26 can be mounted to the vehicle 49 after the vehicle 49 has been manufactured, such that the receiver 16 is an after-market add-on to the vehicle 49.

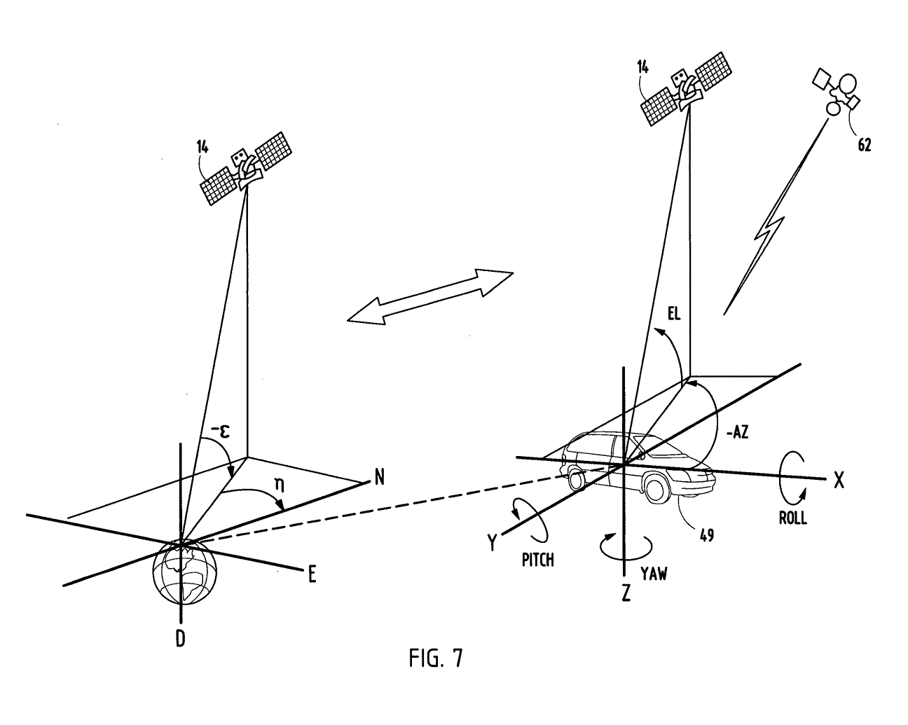

In reference to FIG. 7, the beam positioning of the first antenna 26 is based upon the locational relationship of the satellite 14 and vehicle 49 with respect to the Earth. In one embodiment, the vehicle 49 includes a global positioning satellite (GPS) system that is in communication with a GPS satellite 62, such that the location of the vehicle 49 can be determined using GPS coordinates. The location of the satellite 14 with respect to the vehicle 49 on the surface of the Earth can be calculated from the longitudinal and latitudinal coordinates of both the satellite 14 and the vehicle 49 in terms of the azimuth and elevation pointing angles (η, ε), which are referenced with respect to the North, East, and Down (NED) Earth coordinate system.

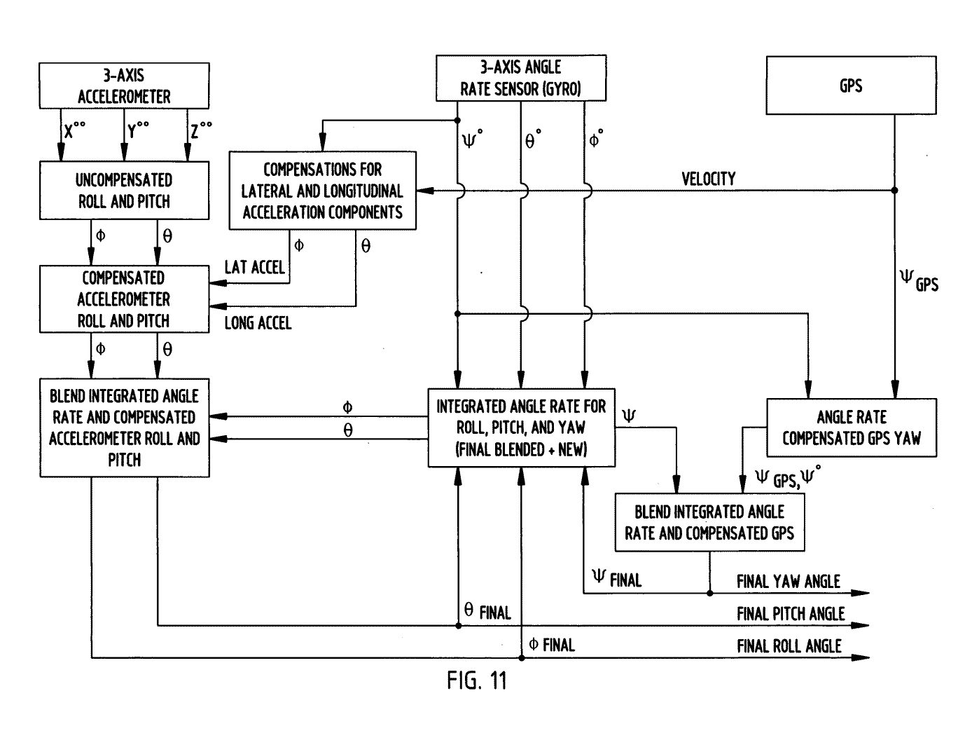

A different coordinate system defined in terms of X, Y, and Z axes, can be specified for the vehicle 49 such that the vehicle's 49 orientation and tilt on the surface of the Earth can be related to angles in the NED coordinate system. In the vehicle's 49 coordinate system the X-axis is aligned with the forward direction of the vehicle 49, and the Y-axis is orthogonal to the X-axis and directed towards right side of the vehicle 49, and the Z-axis is orthogonal to the plane formed by the X and Y axes and is directed below the vehicle 49. The vehicle 49 coordinate system is related to the Earth coordinate system based upon Euler angles of roll, pitch, and yaw (FIG. 11). The azimuth and elevation angles (η, ε) of the satellite 14 in the Earth's coordinate system can be converted into azimuth and elevation angles (Az, El) in the vehicle 49 coordinate system.

By determining the angular position of the satellite 14 to the vehicle's 49 position on the Earth, and converting this angular position to the corresponding angular position in the vehicle 49 coordinate system, the angular pointing from the vehicle 49 to the satellite 14 can be determined, thereby, allowing for the first antenna 26 to be positioned. Typically, the first antenna 26 operates in the same coordinate system as the vehicle 49, such that the first antenna 26 can be positioned using the elevation (El) and azimuth (Az) angles in the vehicle 49 coordinate system. According to one embodiment, the locational relationship between the satellite 14 and vehicle 49 is further described in U.S. Pat. No. 7,009,558, entitled “VEHICLE MOUNTED SATELLITE TRACKING SYSTEM,” the entire disclosure of which is hereby incorporated herein by reference.

According to one embodiment, the vehicle 49 also includes a three-axis (3-axis) accelerometer for determining the tilt angles of the vehicle 49 relative to the “down” gravitational acceleration vector in the X-Z planes and the Y-Z planes, as illustrated in FIG. 11. Further, a three-axis (3-axis) gyro is included for measuring the rate of change of the roll, pitch, and yaw angles. A GPS can also be included to determine vehicle 49 speed and heading. The fusing of these three (3) sensors (e.g., the three-axis (3-axis) accelerometer, the three-axis (3-axis) gyro, and the GPS) is used to calculate an accurate vehicle 49 attitude. The tilt angles derived from the accelerometers can be corrupted by vehicle 49 lateral and longitudinal accelerations caused by movements of the vehicle 49, such as, but not limited to, cornering, accelerating, braking, the like, or a combination thereof. The corrupting lateral and longitudinal accelerations can be compensated by using speed from the GPS and yaw rate from the gyro. A blending of integrated angle rate and compensated accelerometer tilt can then be used to determine an accurate roll and pitch of the vehicle 49. A blending of integrated yaw and angle rate compensated GPS can then be used to determine an accurate yaw.

In reference to both FIGS. 1 and 2, the second antenna 28 is typically an omnidirectional antenna that is configured to receive terrestrial RF signals from the terrestrial repeater 30. The terrestrial repeater 30 receives the data from the satellite 14 and retransmits the data in a terrestrial RF signal that is received by the second antenna 28. If the first antenna 26 cannot receive the signal from the satellite 14, such as if the line of sight is being blocked, the second antenna 28 may be able to receive the signal from the terrestrial repeater 30, which would prevent the receiver 16 from completely losing contact with the satellite 14, or failing to receive the transmitted data.

According to an exemplary embodiment, by configuring the receiver 16 to receive signals concurrently and/or temporally interleaving the transmitted data, using both antennas 26,28, both of the signals received by the first and second antennas 26,28 would have to be blocked or otherwise not received for a period of time up to approximately twenty-five (25) seconds before the output 39 is substantially affected. It should be appreciated by those skilled in the art that the data can be temporally interleaved, such that the first and second antennas can be blocked for a period of time greater than approximately twenty-five seconds (25 s), according to one embodiment. Additionally or alternatively, the terrestrial repeater 30 can be used as a back channel for communications to the source provider 18 or other content providers, wherein a data connection manager can determine which data connection is adequate, such as, but not limited to, by signal strength bandwidth requirements, the like, or a combination thereof.

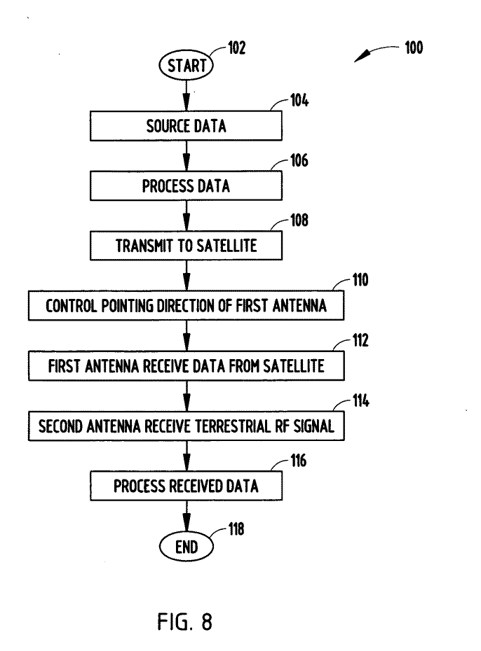

With respect to FIGS. 1-8, a method of communicating the signal is generally shown at reference indicator 100 in FIG. 8. The method 100 starts at step 102, and proceeds to step 104, wherein the source data is obtained from the source provider 18. At step 106, the data is processed, such as encoding the data using the encoder 19, interleaving the data using the interleaving device 20, encoding the data using the encoder 24, modulating the data using the modulator 22, or a combination thereof, according to one embodiment.

The method 100 then proceeds to step 108, wherein the data is transmitted or uplinked to the satellite 14. The first antenna 26 is controlled to alter or change the pointing direction, at step 110 to be directed towards the satellite 14. At step 112, the first antenna 26 receives the data from the satellite 14. At step 114, the second antenna 28 receives the terrestrial RF signal from the terrestrial repeater 30. It should be appreciated by those skilled in the art that depending upon the location of the vehicle 49 and line-of-sight blockages to the received signals, one or both of the first and second antennas 26,28 may receive the data or terrestrial RF signals, respectively, at a given time.

At step 116, the receiver 16 processes the data received by the first and second antennas 26,28, such that the receiver 16 demodulates the data or signal by demodulators 32A,32B, decodes the data using the decoders 36A,36B, de-interleaves the data using the de-interleaving devices 33A,33B, decodes the data using decoders 38A,38B, time align and combines the data using the time align and combine device 34, or a combination thereof, according to one embodiment. The method 100 then ends at step 118.

By way of explanation and not limitation, in operation, the communication system 10 and method 100 are used for transmitting and receiving data (e.g., image data, such as a satellite television broadcast), particularly while the receiver 16 is mobile, such as being integrated in a vehicle, airplane, train, boat or watercraft, or other mobile device or apparatus. By transmitting the data in an interleaving format, wherein the data can be corrected during extended periods of signal blockage, the receiver 16 can accurately correct errors when a portion of the data is not received. A portion of the data may not be received by the receiver 16 due to noise in the data, interference from other signals, or line of sight blockages between the satellite 14 and receiver 16.

Further, the first antenna 26 having a wide beamwidth in combination with being controlled to alter or change the pointing direction, allows the first antenna 26 to be directed towards the desirable satellite 14 in order to receive the data. The desired pointing direction of the first antenna 26 is determined based upon the locational relationship between the satellite 14 and the vehicle 49, the attitude of the vehicle 49, or other mobile apparatus that the first antenna 26 and receiver 16 are mounted or connected. Thus, the pointing direction of the first antenna 26 in combination with the second antenna 28 receiving the terrestrial RF signal from the terrestrial repeater 30, allows the receiver 16 to receive the data in order to produce a desirable audio and/or video output, even during extended periods of signal blockages or line-of-sight blockages.

The communication system 10 and method 100 are generally used for receiving satellite television signals when the receiver 16 is mobile, such as being used on the vehicle 49. Thus, the pointing direction of the first antenna 26 can be altered as the receiver 16 is moving in order to be directed towards the satellite 14. The receiver 16 can then emit the audio and/or video output 39, which is then displayed on a television inside the vehicle 49. Additionally, by transmitting the signals in a time and/or spatial diversity format, as the vehicle 49 moves and the first antenna 26 or the second antenna 28 are obstructed, the output 39 will continue to be emitted.

Advantageously, the communication system 10 and method 100 have the ability to extract weak signals from an environment saturated with RF signals due to the design of the first antenna 26, and to produce a quality output due to the format of the data transmission. Also, the second antenna 28 receiving terrestrial RF signals from the terrestrial repeater 30 increases the probability that the data transmitted from the transmitter 14 is received by the receiver 16 to produce the audio and/or video output 39. Further, the size of the first antenna 26 creates an aesthetically pleasing design, such that the first antenna 26 can be mounted or connected to a vehicle 49, airplane, train, boat or other watercraft, or other mobile device or apparatus without being very noticeable, such as the current mobile antennas used to receive satellite television signals. Additionally, the minimal size of the first antenna 26 results in a wide antenna beam, such that the antenna does not need to track the satellite 14 as accurately as a larger antenna having a narrower beam. It should be appreciated by those skilled in the art that the system 10 and method 100 may have additional or alternative advantages. It should further be appreciated by those skilled in the art that the above described elements can alternatively be combined.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims, as interpreted according to the principles of patent law, including the doctrine of equivalents.

1. A communication system comprising:
a source provider that provides image data;
at least one transmitter that transmits said image data obtained from said source provider;
at least one satellite in communication with said at least one transmitter, wherein said at least one satellite receives and retransmits said image data; and
at least one receiver in communication with said at least one satellite and adapted to receive said retransmitted image data, wherein said at least one receiver is mobile and comprises at least one antenna comprising:
a first antenna having a horizontal length of less than approximately twelve inches (12 in.) (30.48 cm).

2. The communication system of claim 1, wherein said first antenna is a planar array antenna that is substantially flat and has a vertical height of less than approximately two inches (2 in.) (5.08 cm).

3. The communication system of claim 1, wherein said first antenna comprises an antenna layer and a down-converter layer.

4. The communication system of claim 1, wherein a pointing direction of said first antenna is at least one of mechanically and electronically controlled.

5. The communication system of claim 4 further comprising a pointing device operably connected to said first antenna, wherein said pointing device rotates said first antenna.

6. The communication system of claim 4, wherein said first antenna's beam is electronically controlled.

7. The communication system of claim 1, wherein said at least one antenna further comprises a second antenna that is an omnidirectional antenna.

8. The communication system of claim 7 further comprising a terrestrial repeater in communication between said satellite and said second antenna, wherein said terrestrial repeater receives said image data from said satellite and transmits said image data using a terrestrial radio frequency (RF) signal, which is received by said second antenna.

9. The communication system of claim 1, wherein said image data is transmitted as data bits in a temporal interleaving format.

10. The communication system of claim 9, wherein said temporal interleaved data bits are transmitted over a time period of greater than ten seconds (10 s).

11. The communication system of claim 1, wherein said at least one satellite is a geostationary orbit (GEO) satellite.

12. The communication system of claim 1, wherein said receiver receives said image data from a plurality of satellites of said at least one satellite.

13. The communication system of claim 1, wherein said receiver is connected to one of a vehicle, airplane, train, boat, and watercraft.

14. The communication system of claim 1, wherein said image data is transmitted at a bit rate of above approximately five hundred kilobytes per second (500 Kb/s).

15. A method of satellite communication, said method comprising the steps of:
interleaving image data;
transmitting said interleaved image data to at least one satellite;
receiving and retransmitting said interleaved image data by said at least one satellite;
receiving said retransmitted interleaved image data by at least one receiver from said at least one satellite, wherein said at least one receiver is mobile; and
de-interleaving said image data, such that said receiver employs an error correction technique to emit a substantially error free output when said receiver's visibility to said at least one satellite is blocked for a period of time up to approximately twenty-five seconds (25 s).

16. The method of claim 15 further comprising the step of providing said receiver comprising a first antenna, wherein said first antenna is a planar array antenna that is substantially flat, and has a horizontal length of less than approximately twelve inches (12 in.) (30.48 cm) and a vertical height of approximately less than two inches (2 in.) (5.08 cm).

17. The method of claim 16 further comprising the step of controlling said first antenna's beam by at least one of a mechanical device and an electronic device.

18. The method of claim 15 further comprising the step of providing said receiver comprising a second antenna, wherein said second antenna is an omnidirectional antenna.

19. The method of claim 15 further comprising the step of receiving said image data from said at least one satellite by at least one terrestrial repeater, and said at least one terrestrial repeater retransmitting said image data as a radio frequency (RF) signal.

20. The method of claim 15, wherein said interleaved image data is temporally interleaved, such that temporally interleaved data bits of said temporally interleaved image data are transmitted over a time period of greater than approximately ten seconds (10 s).

21. The method of claim 15, wherein said receiver is connected to one of a vehicle, airplane, train, boat, and watercraft.

22. The method of claim 15 further comprising the steps of:
modulating said image data by a modulator in said transmitter; and
encoding said image data by an encoder in said transmitter.

23. The method of claim 22 further comprising the steps of:
demodulating said image data by a demodulator in said receiver;
combining and time aligning said image data by a time align and combine device in said receiver; and
decoding said image data by at least one decoder in said receiver.

24. The method of claim 15, wherein said image data is transmitted at a bit rate of above approximately five hundred kilobytes per second (500 Kb/s).
